(19) United States
(12) Patent Application Publication
(10) Pub. No.: US 2004/0105202 A1
(43) Pub. Date: Jun. 3, 2004

(54) Electrostatic discharge protection device and method using depletion switch

(75) Inventors: Chyh-Yih Chang, Hsinchu (TW); Hsin-Chin Jiang, Hsinchu (TW); Ming-Dou Ker, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Industrial Technology Research Institute

(21) Appl. No.: 10/307,969

(22) Filed: Dec. 3, 2002

(51) Int. Cl. H02H 9/00

(52) U.S. Cl. 361/56

(57) ABSTRACT

An integrated circuit device for electrostatic discharge protection that includes a semiconductor substrate, a lightly doped region of a first dopant type formed in the substrate, a first diffusion region of the first dopant type formed at least partially in the lightly doped region, a second diffusion region of the first dopant type formed at least partially in the lightly doped region and spaced apart from the first diffusion region, a resistive path defined by the lightly doped region, the first and the second diffusion regions, and a third diffusion region of a second dopant type formed in the lightly doped region, and disposed between and spaced apart from the first and the second diffusion regions, wherein the third diffusion region keeps the resistive path at a low resistive state until a normal operation period occurs.

### DESCRIPTION

1. Related Field

This invention pertains in general to a semiconductor device and, more particularly, to an electrostatic discharge protection device using a depletion switch and a method thereof.

2. Background of the Invention

A semiconductor integrated circuit (“IC”) is generally susceptible to an electrostatic discharge (“ESD”) event, which may damage or destroy the IC, such as advanced MOSFET transistors. An ESD event is an electrical discharge of a current (positive or negative) for a short duration during which a large amount of current is provided to the IC. The high current may be built-up from a variety of sources, such as the human body and machines, referred to as the human body model (HBM) and machine model (MM), respectively. An IC is susceptible to the HBM and MM during transportation or handling.

Advanced MOSFET transistors, such as those manufactured using sub-quarter-micron processes, have traditionally required certain properties such as short channel lengths, low threshold voltages, and thin gate oxide layers. The gate oxide thickness of a transistor may shrink to 2 nano meter (nm) or even smaller in 0.15-μm Complementary Metal Oxide Semiconductor (CMOS) processes. In “Very Fast Transmission Line Pulsing of Intergrated Structures and the Charged Device Model,” IEEE Trans. On Components, Packaging, and Manufacturing Technology—Part C, vol. 21, pp. 278-285, 1998, Horst Gieser and Markus Haunschild indicate that the breakdown field of gate oxide ranges from 14 MV/cm (mega volts per centimeter) to 17 MV/cm under the HBM/MM ESD events. In addition, according to SIA's ITRS 2000 update, the gate oxide thickness of a transistor will shrink to 1.5 nm in the year 2005, and 0.6 nm in the year 2014. Given the above, for a gate oxide breakdown field of 16 MV/cm, the breakdown voltage of a 1.5 nm gate oxide in the year 2005 is expected to be 2.4V (=16 MV/cm*1.5 nm), and the breakdown voltage of a 0.6 nm gate oxide in the year 2014 is expected to be 0.96V (=16 MV/cm*0.6 nm). For ultra thin gate oxides with such breakdown voltages, conventional ESD protection devices triggered by a junction breakdown mechanism may be no longer effective. To achieve ESD protection while dimension scaling, it is desired to provide an ESD protection device that includes an efficient and quick trigger-on or turn-on mechanism. Examples of conventional ESD protection devices which are triggered on by a depletion mechanism instead of a junction breakdown mechanism, and which are quickly triggered on are shown in FIGS. 1 and 2, respectively.

FIG. 1 is a reproduction of FIG. 17 of U.S. Pat. No. 5,925,922 (hereinafter the '922 patent) to Rountree et al., entitled “Depletion Controlled Isolation Stage.” The '922 patent discloses an input ESD protection circuit that includes an SCR (P+24, N-well 14, Psub 12 and N+28) and an N-well resistor (N+18, N-well 14 and N+16). In operation, when a high voltage such as an ESD zap occurs at an input bond pad, a depletion region (enveloped by dotted lines 22 and 30) is induced. The depletion region includes an upper boundary 22 disposed in the N-well 14 and a lower boundary 30 disposed in the p-type substrate 12. The '922 patent provides a depletion mechanism instead of a junction breakdown mechanism to trigger an ESD protection circuit. However, the '922 patent may not quickly trigger on an ESD protection circuit.

FIG. 2 is a reproduction of FIG. 2 of U.S. Pat. No. 6,256,184 (hereinafter the '184 patent) to Gauthier Jr. et al., entitled “Method and Apparatus for Providing Electrostatic Discharge Protection.” The '184 patent discloses an ESD protection device that includes a low threshold voltage FET having a quicker turn-on speed than conventional GGNMOS (grounded gate NMOS) during an ESD event.

In operation, the low threshold voltage FET needs a relatively low voltage bias to turn on and therefore responds quickly to an ESD event. The '184 patent provides a quick turn-on yet junction breakdown mechanism to trigger an ESD protection circuit.

As mentioned above, a junction breakdown mechanism may be no longer effective for ESD protection in the near future.

### SUMMARY OF THE INVENTION

Accordingly, the present invention is directed to ESD protection devices that obviate one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the devices and methods particularly pointed out in the written description and claims thereof, as well as the appended drawings.

To achieve these and other advantages, and in accordance with the purpose of the invention as embodied and broadly described, there is provided an integrated circuit device for electrostatic discharge protection that includes a semiconductor substrate, a lightly doped region of a first dopant type formed in the substrate, a first diffusion region of the first dopant type formed at least partially in the lightly doped region, a second diffusion region of the first dopant type formed at least partially in the lightly doped region and spaced apart from the first diffusion region, a resistive path defined by the lightly doped region, the first and the second diffusion regions, and a third diffusion region of a second dopant type formed in the lightly doped region, and disposed between and spaced apart from the first and the second diffusion regions, wherein the third diffusion region keeps the resistive path at a low resistive state until a normal operation period occurs.

In one aspect of the present invention, a depletion region is formed at a p-n junction disposed between the lightly doped region and the third diffusion region as the normal operation period occurs.

Also in accordance with the present invention, there is provided an integrated circuit device for electrostatic discharge protection that includes a semiconductor substrate, an insulation layer formed over the substrate, a lightly doped region of a first dopant type formed over the insulation layer, a first diffusion region of the first dopant type formed at least partially in the lightly doped region, a second diffusion region of the first dopant type formed at least partially in the lightly doped region and spaced apart from the first diffusion region, a resistive path defined by the lightly doped region, the first and the second diffusion regions, and a third diffusion region of a second dopant type formed in the lightly doped region, and disposed between and spaced apart from the first and the second diffusion regions, wherein the third diffusion region keeps the resistive path at a low resistive state until a normal operation period occurs.

In one aspect of the present invention, the lightly doped region, the first diffusion region, the second diffusion region, and the third diffusion region are of a same depth.

Still in accordance with the present invention, there is provided an electrostatic discharge protection circuit that includes a first terminal, a second terminal, an integrated circuit device including a lightly doped region of a first dopant type, a first diffusion region of the first dopant type formed at least partially in the lightly doped region and electrically coupled to the first terminal, a second diffusion region of the first dopant type formed at least partially in the lightly doped region and spaced apart from the first diffusion region and electrically coupled to the second terminal, and a third diffusion region of a second dopant type formed in the lightly doped region, and disposed between and spaced apart from the first and the second diffusion regions, the third diffusion region keeping a low resistive path between the first and second terminals until a normal operation period occurs, and a control circuit for inducing a depletion region in the lightly doped region as the normal operation period occurs.

Yet still in accordance with the present invention, there is provided a method of electrostatic discharge protection that includes providing an integrated circuit device including a lightly doped region of a first dopant type, a first diffusion region of the first dopant type formed at least partially in the lightly doped region, a second diffusion region of the first dopant type formed at least partially in the lightly doped region and spaced apart from the first diffusion region, a resistive path defined by the lightly doped region, the first and the second diffusion regions, and a third diffusion region of a second dopant type formed in the lightly doped region, and disposed between and spaced apart from the first and the second diffusion regions, the third diffusion region controlling the resistive state of the resistive path, and keeping the resistive path at a low resistive state until a normal operation period occurs.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings,

FIG. 1 shows a circuit diagram of a conventional ESD protection

FIG. 2 shows a schematic circuit diagram of another conventional ESD protection device;

FIG. 3 shows a schematic view of a depletion switch in accordance with one embodiment of the present invention;

FIG. 4 shows a cross-sectional view of a depletion switch in accordance with one embodiment of the present invention;

FIG. 5 shows an ESD protection circuit in accordance with one embodiment of the present invention;

FIGS. 6A and 6B show a depletion switch operating during an ESD event;

FIGS. 7A and 7B show a depletion switch operating during a normal operation period;

FIG. 8 shows an ESD protection circuit in accordance with one embodiment of the present invention;

FIGS. 9A, 9B and 9C show a rotated clockwise top view of the circuit shown in FIG. 8;

FIGS. 10A and 10B show the circuit shown in FIG. 8 operating during an ESD event;

FIGS. 11A and 11B show the circuit shown in FIG. 8 operating during a normal operation period;

FIG. 12 shows an ESD protection circuit in accordance with another embodiment of the present invention;

FIGS. 13A and 13B show a rotated clockwise top view of the circuit shown in FIG. 12;

FIGS. 14A and 14B show the circuit shown in FIG. 12 operating during an ESD event; and

FIGS. 15A and 15B show the circuit shown in FIG. 12 operating during a normal operation period.

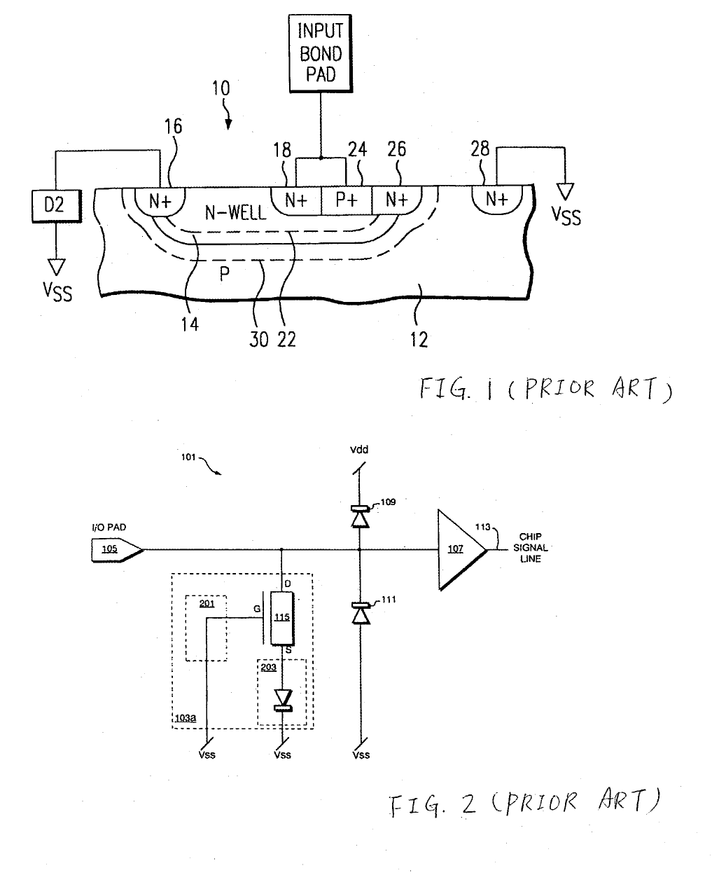

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

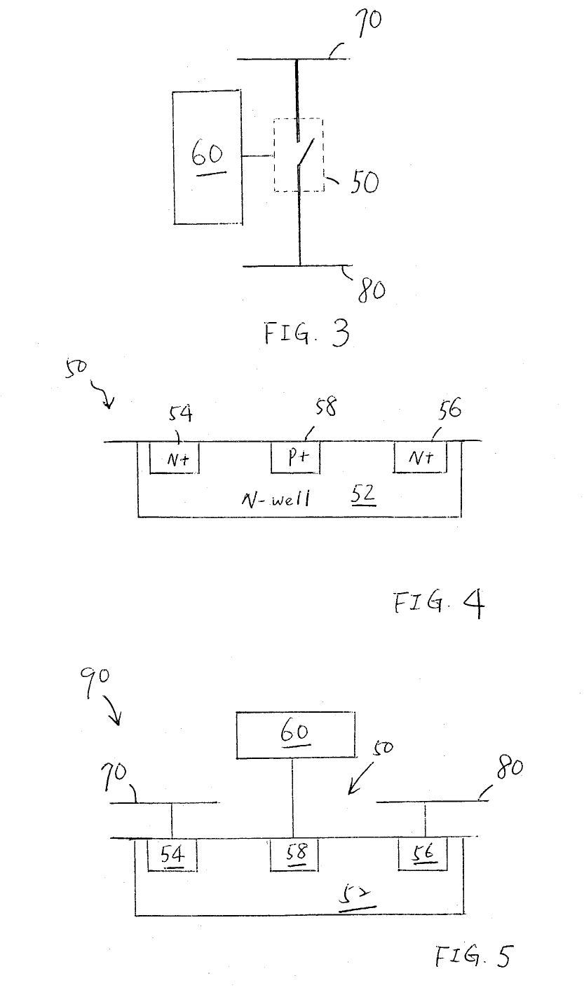

FIG. 3 shows a schematic view of a depletion switch 50 consistent with an exemplary embodiment of the present invention. As used herein, “depletion switch” means an integrated circuit device in which a resistive path is kept at a low resistive state between two terminals to allow for an ESD current to be conducted through the low resistive path as an ESD event occurs, and in which a depletion region is induced to change the resistive path to a high resistive state as a normal operation period occurs. As also used herein, “normal operation period” means a period during which no ESD events occur. The depletion region induced in a normal operation period is not removed until another ESD event occurs.

Referring to FIG. 3, depletion switch 50 is coupled between ESD paths 70 and 80, and may be coupled to a control circuit 60 for inducing a depletion region (not shown) in depletion switch 50. In one embodiment, ESD path 70 is a voltage line or contact pad, and ESD path 80 is another voltage line or contact pad. In operation, depletion switch 50 is initially in a closed state (not shown) by fabrication so that, during an ESD event, an ESD current (not shown) is conducted from ESD path 70 to ESD path 80, or vice versa. Therefore, depletion switch 50 is an initial-on device without any trigger signals for starting an ESD conduct mechanism as an ESD event occurs. That is, depletion switch 50 conducts an ESD current without any delay. On the other hand, depletion switch 50 isolates ESD paths 70 and 80 from one another during a normal operation period so that leakage current flowing between ESD paths 70 and 80 is minimized. To isolate ESD paths 70 and 80, as will be discussed in more detail in the following paragraphs, a depletion region (not shown) is induced in depletion switch 50 to form a high resistive path therein, changing depletion switch 50 into an open state.

FIG. 4 shows a cross-sectional view of depletion switch 50. Referring to FIG. 4, depletion switch 50 includes an N-well 52 formed in a semiconductor substrate (not shown) or over an insulation layer (not shown), a first n-type region 54 formed in N-well 52, a second n-type region 56 formed in N-well 52 and spaced apart from first n-type region 54, and a p-type region 58 disposed between and spaced apart from first and second n-type regions 54 and 56. In one embodiment, first n-type region 54 or second n-type region 56 overlaps N-well 52 and is not fully disposed within N-well 52. A resistive path (not shown) is thus defined in N-well 52 by first n-type region 54, N-well 52 and second n-type region 56. The resistive state of the resistive path, primarily due to a sheet resistance in N-well 52, is kept at a low value, resulting in an initial-on depletion switch that is ready to conduct an ESD current as an ESD event occurs. Although a depletion switch including a p-type region in an N-well is shown, persons skilled in the art will recognize that a depletion switch may be fabricated with an n-type region in a P-well.

FIG. 5 shows an ESD protection circuit 90 in accordance with one embodiment of the present invention. Referring to FIG. 5, ESD protection circuit 90 includes depletion switch 50, control circuit 60 and ESD paths 70 and 80, in which first n-type region 54, second n-type region 56 and p-type region 58 of depletion switch 50 are coupled to ESD path 70, ESD path 80 and control circuit 60, respectively. In one embodiment, control circuit 60 is a pump circuit or bias source that provides a positive, negative or ground signal.

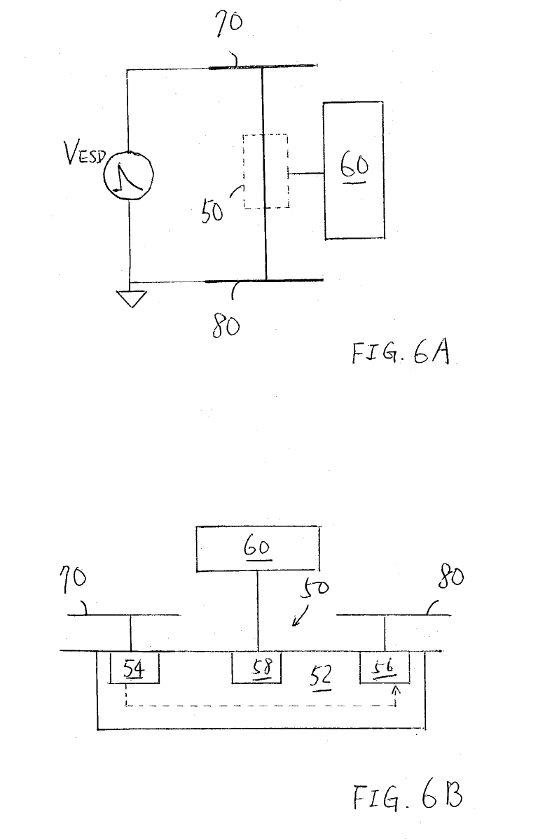

FIGS. 6A and 6B show depletion switch 50 operating during an ESD event. Referring to FIG. 6A, since depletion switch 50 is initially in a closed state by fabrication, a positive ESD zap occurring at ESD path 70 is conducted to ESD path 80 through depletion switch 50. Referring to FIG. 6B, since the resistive path (not shown) in N-well 52 is still kept at a low resistive state, an ESD current (shown by dotted line) is conducted from ESD path 70, first n-type region 54, second n-type region 56 to ESD path 80.

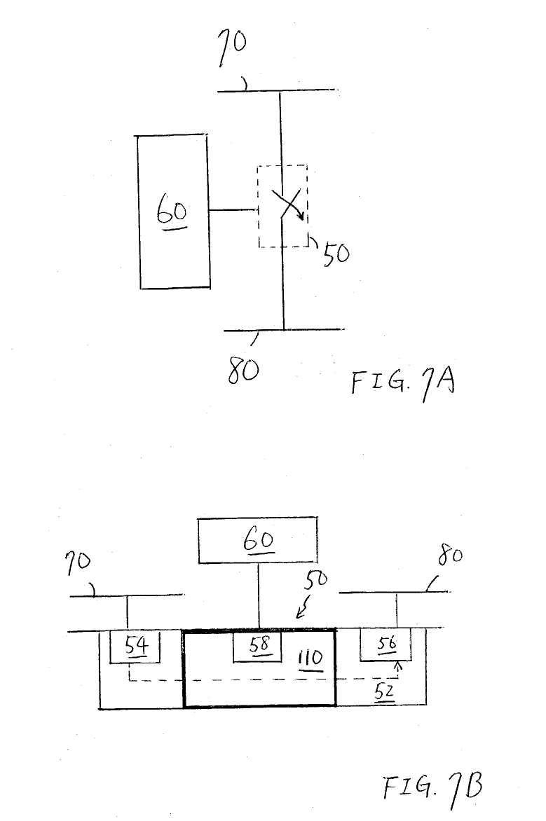

FIGS. 7A and 7B show depletion switch 50 operating during a normal operation period. Referring to FIG. 7A, as an IC (not shown) including depletion switch 50 operates in a normal operation period, for example, as the IC is powered on, control circuit 60 generates a signal to open depletion switch 50. Depletion switch 50 in an open state isolates ESD paths 70 and 80 from one another, thereby decreasing leakage current flowing between ESD paths 70 and 80. Referring to Fig. 7B, the signal generated by control circuit 60 induces a depletion region 110 (shown by a bolded line area) at a p-n junction disposed between p-type region 58 and N-well 52. Depletion region 110 changes the resistive path (not shown) to a high resistive state, minimizing the current flow (shown by dotted line) between first n-type region 54 and second n-type region 56. Depletion region 110 is not removed until control circuit 60 outputs a signal to p-type region 58 upon occurrence of another ESD event. Removal of depletion region 110 results in a low resistive path for the ESD event.

In one embodiment, depletion region 110 approximately reaches a bottom surface of N-well 52 so that leakage current is minimized. The width of depletion region 110 is controlled by a reverse bias voltage, as given by

W=[(2εV/q)(1/Nₐ+1/N_{d})]^{½}

where W is the depletion width, ε is the dielectric constant of silicon, V is the reverse bias voltage applied across a p-n junction, q is the magnitude of an electronic charge, N_{d} is donor impurity concentration in number of donor atoms per cubic cm, and Nₐ is acceptor impurity concentration in number of acceptor atoms per cubic cm. The width of depletion region 110 is controllable such that depletion region 110 reaches a bottom surface of N-well 52. In one embodiment, the width of depletion region 110 is approximately 0.334 μm.

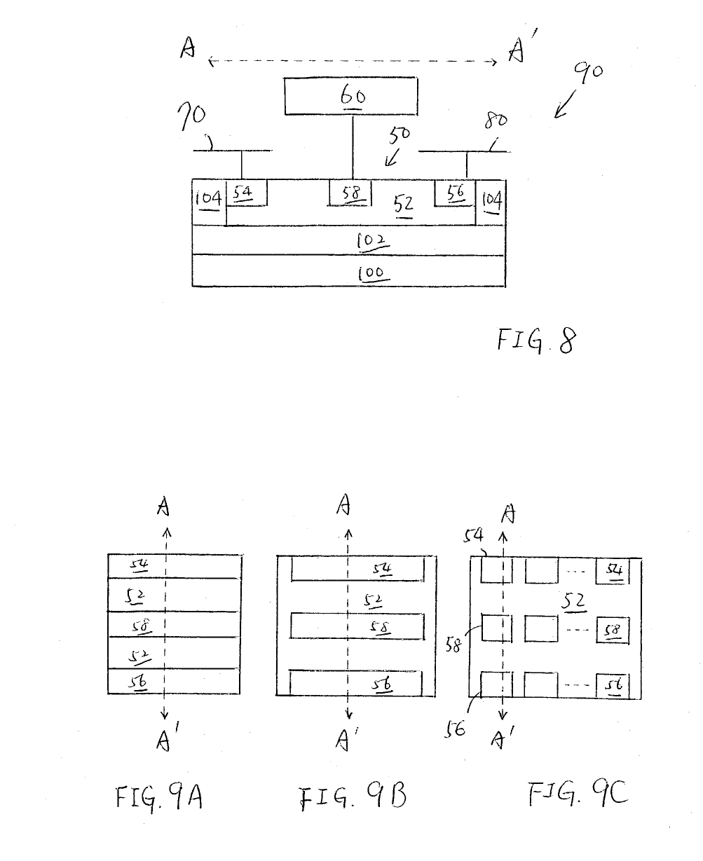

FIG. 8 shows ESD protection circuit 90 in accordance with an exemplary embodiment of the present invention. N-well 52 is formed over an insulation layer 102 which is formed over a semiconductor substrate 100, resulting in a silicon-on-insulator (SOI) structure. Integrated circuit (IC) devices fabricated over a thin SOI layer, as opposed to those fabricated in a much thicker bulk silicon structure, may have lower parasitic capacitance and greater channel currents which, in turn, result in faster speeds. Shallow trench isolations (STI) 104 are disposed adjacent to N-well 52. First n-type region 54 and second n-type region 56 are formed in N-well 52. In one embodiment, however, first n-type region 54 or second n-type region 56 overlaps N-well 52 and is not fully disposed within N-well 52. A rotated clockwise top view of N-well 52 along the A-A′ direction is shown in FIGS. 9A to 9C.

Referring to FIG. 9A, first n-type region 54, p-type region 58 and second n-type region 56 have a length substantially equal to the width of N-well 52. A resistive path (not shown) is disposed under p-type region 58 from first n-type region 54 to second n-type region 56. Referring to FIG. 9B, since first n-type region 54, p-type region 58 and second n-type region 56 have a length shorter than the width of N-well 52, a resistive path (not shown) may be disposed under or beside p-type region 58. Referring to FIG. 9C, first n-type region 54, p-type region 58 or second n-type region 56 includes a plurality of diffusion regions 54, 56 and 58. A resistive path (not shown) is disposed under or beside p-type regions 58 from first n-type regions 54 to second n-type regions 56.

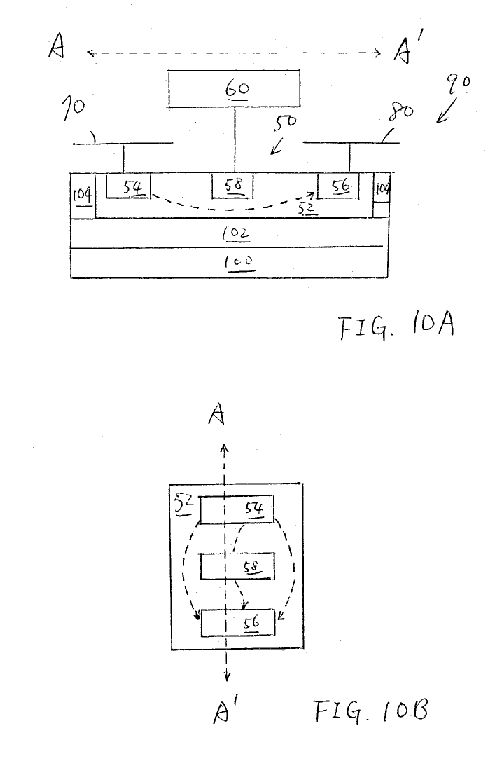

FIGS. 10A and 10B show ESD protection circuit 90 shown in FIG. 8 operating during an ESD event. Referring to FIG. 10A, since depletion switch 50 is initially in a closed state by fabrication, p-type region 58 keeps the resistive path (not shown) at a low resistive state, which allows an ESD current (shown by dotted line) to flow from ESD path 70, first n-type region 54, N-well 52, second n-type region 56 to ESD path 80 as an ESD event occurs. Control circuit 60 is inactive until a normal operation period occurs. Referring to FIG. 10B, the ESD current may flow under or beside p-type region 58 from first n-type region 54 to second n-type region 56.

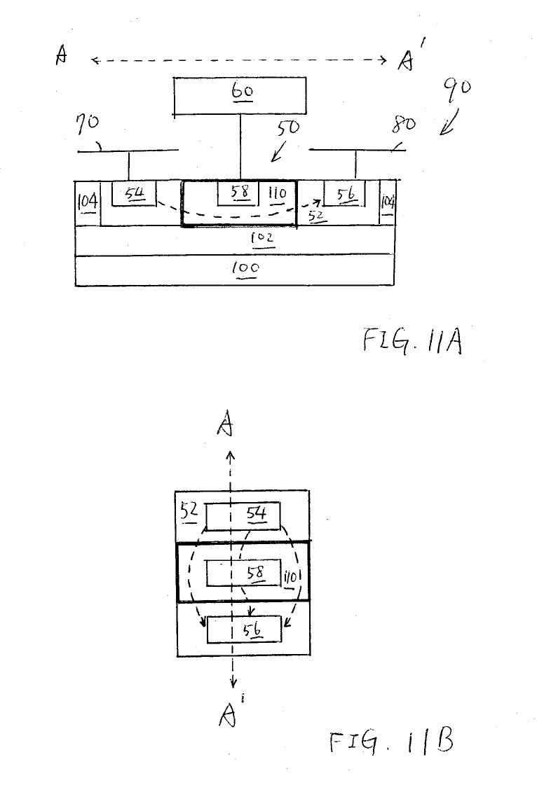

FIGS. 11A and 11B show ESD protection circuit 90 shown in FIG. 8 operating during a normal operation period. Referring to FIG. 11A, control circuit 60 generates a signal to induce depletion region 110 (shown by a bolded line area) in N-well 52. Depletion switch 50 switches to an open state that isolates ESD paths 70 and 80 from one another, thereby decreasing leakage current flowing between ESD paths 70 and 80. Depletion region 110 is formed at a p-n junction disposed between p-type region 58 and N-well 52. In one embodiment, depletion region 110 approximately reaches a bottom surface of N-well 52. Referring to FIG. 11B, the existence of depletion region 110 changes the resistive path (not shown) to a high resistive state, minimizing the current flow (shown by dotted line) between first n-type region 54 and second n-type region 56. Depletion region 110 is not removed until control circuit 60 outputs a signal to p-type region 58 upon occurrence of another ESD event. Removal of depletion region 110 results in a low resistive path for the ESD event.

FIG. 12 shows an ESD protection circuit 120 in accordance with another embodiment of the present invention. Referring to FIG. 12, ESD protection circuit 120 includes a depletion switch 130, control circuit 60, and ESD paths 70 and 80. Depletion switch 130 includes an N-well 132 formed over an insulation layer 102 which is formed over a semiconductor substrate 100, a first n-type region 134 coupled to ESD path 70, a second n-type region 136 coupled to ESD path 80, and a p-type region 138 spaced apart from first n-type region 134 and second n-type region 136 and coupled to control circuit 60. In one embodiment, first n-type region 134 or second n-type region 136 overlaps N-well 132 and is not fully disposed within N-well 132. In the embodiment shown in FIG. 12, first n-type region 134, second n-type region 136, p-type region 138 and N-well 132 are of a same depth.

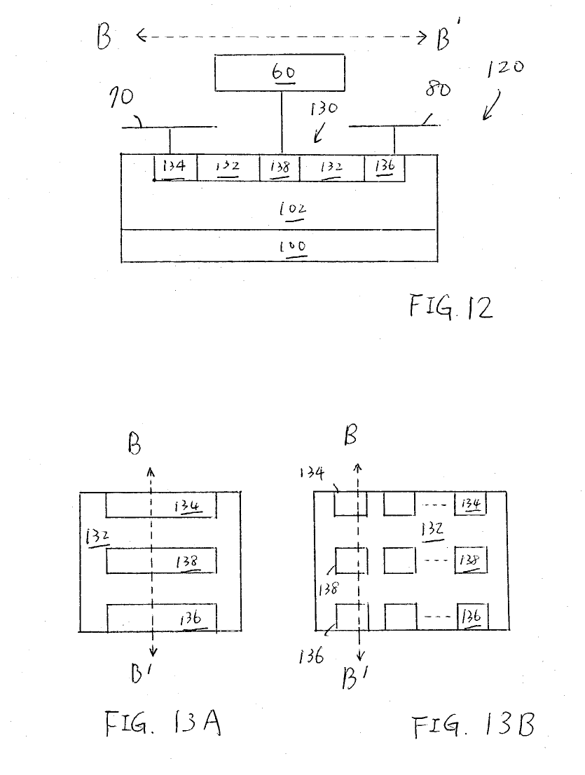

FIGS. 13A and 13B show a rotated clockwise top view of N-well 132 along the B-B′ direction. Referring to FIG. 13A, a resistive path (not shown) is disposed beside p-type region 138 from first n-type region 134 to second n-type region 136. Referring to FIG. 13B, first n-type region 134, p-type region 138 or second n-type region 136 includes a plurality of diffusion regions 134, 136 or 138, respectively. A resistive path (not shown) is disposed beside p-type regions 138 from first n-type regions 134 to second n-type regions 136.

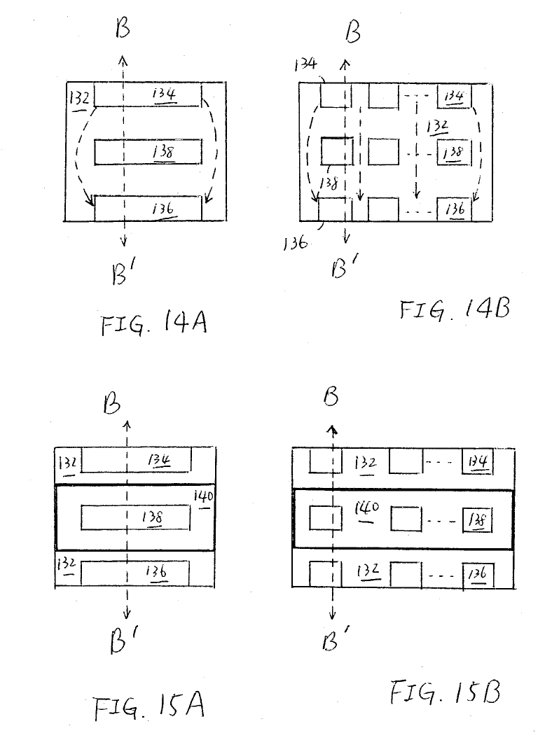

FIGS. 14A and 14B show ESD protection circuit 120 shown in FIG. 12 operating during an ESD event. Referring to FIGS. 14A and 14B, since depletion switch 130 is initially in a closed state by fabrication, p-type region 138 keeps a resistive path (not shown) at a low resistive state, which allows an ESD current (shown by dotted line) to flow beside p-type region 138 from first n-type region 134, N-well 132 to second n-type region 136 as an ESD event occurs. Control circuit 60 is inactive until a normal operation period occurs.

FIGS. 15A and 15B show ESD protection circuit 120 shown in FIG. 12 operating during a normal operation period. Referring to FIGS. 15A and 15B, control circuit 60 generates a signal to induce a depletion region 140 (shown by a bolded line area) in N-well 132. Depletion switch 130 switches to an open state that isolates ESD paths 70 and 80 from one another, thereby decreasing leakage current flowing between ESD paths 70 and 80. Depletion region 140 is formed at a p-n junction disposed between p-type region 138 and N-well 132. In one embodiment, depletion region 140 approximately reaches a bottom surface of N-well 132. The existence of depletion region 140 changes a resistive path (not shown) in N-well 132 to a high resistive state, and is not removed until control circuit 60 outputs a signal to p-type region 138 upon occurrence of another ESD event. Removal of depletion region 140 results in a low resistive path for the ESD event.

The present invention therefore also provides a method for electrostatic discharge protection. The method comprises providing an integrated circuit device including a lightly doped region of a first dopant type, a first diffusion region of the first dopant type formed at least partially in the lightly doped region, a second diffusion region of the first dopant type formed at least partially in the lightly doped region and spaced apart from the first diffusion region, a resistive path defined by the lightly doped region, the first and the second diffusion regions, and a third diffusion region of a second dopant type formed in the lightly doped region, and disposed between and spaced apart from the first and the second diffusion regions, in which the third diffusion region controls the resistive state of the resistive path, and keeping the resistive path at a low resistive state until a normal operation period occurs.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An integrated circuit device for electrostatic discharge protection, comprising:
a semiconductor substrate;
a lightly doped region of a first dopant type formed in the substrate;
a first diffusion region of the first dopant type formed at least partially in the lightly doped region;
a second diffusion region of the first dopant type formed at least partially in the lightly doped region and spaced apart from the first diffusion region;
a resistive path defined by the lightly doped region, the first and the second diffusion regions; and
a third diffusion region of a second dopant type formed in the lightly doped region, and disposed between and spaced apart from the first and the second diffusion regions,
wherein the third diffusion region keeps the resistive path at a low resistive state until a normal operation period occurs.

2. The device of claim 1, wherein the third diffusion region changes the resistive path to a high resistive state as the normal operation period occurs.

3. The device of claim 1, wherein a depletion region is formed at a p-n junction disposed between the lightly doped region and the third diffusion region as the normal operation period occurs.

4. The device of claim 3, wherein the depletion region is removed as an electrostatic discharge event occurs.

5. The device of claim 3, further comprising a control circuit coupled to the third diffusion region to induce the depletion region as the normal operation period occurs.

6. The device of claim 1, wherein the resistive path is formed under the third diffusion region.

7. The device of claim 3, wherein the depletion region extends to a bottom surface of the lightly doped region.

8. The device of claim 1, wherein the first diffusion region is formed in the lightly doped region.

9. The device of claim 1, wherein the second diffusion region is formed in the lightly doped region.

10. The device of claim 1, wherein the first dopant type is n-type and the second dopant type is p-type.

11. The device of claim 1, wherein the first dopant type is p-type and the second dopant type is n-type.

12. An integrated circuit device for electrostatic discharge protection, comprising:
a semiconductor substrate;
an insulation layer formed over the substrate;
a lightly doped region of a first dopant type formed over the insulation layer;
a first diffusion region of the first dopant type formed at least partially in the lightly doped region;
a second diffusion region of the first dopant type formed at least partially in the lightly doped region and spaced apart from the first diffusion region;
a resistive path defined by the lightly doped region, the first and the second diffusion regions; and
a third diffusion region of a second dopant type formed in the lightly doped region, and disposed between and spaced apart from the first and the second diffusion regions,
wherein the third diffusion region keeps the resistive path at a low resistive state until a normal operation period occurs.

13. The device of claim 12, wherein the lightly doped region, the first diffusion region, the second diffusion region and the third diffusion region are of a same depth.

14. The device of claim 12 or 13, wherein the third diffusion region changes the resistive path to a high resistive state as the normal operation period occurs.

15. The device of claim 12 or 13, wherein a depletion region is formed at a p-n junction disposed between the lightly doped region and the third diffusion region as the normal operation period occurs.

16. The device of claim 15, wherein the depletion region is removed as an electrostatic discharge event occurs.

17. The device of claim 15, further comprising a control circuit coupled to the third diffusion region to induce the depletion region as the normal operation period occurs.

18. The device of claim 13, wherein the resistive path is formed beside the third diffusion region.

19. The device of claim 15, wherein the depletion region extends to a bottom surface of the lightly doped region.

20. The device of claim 12, further comprising an isolation structure formed adjacent to the lightly doped region.

21. The device of claim 12 or 13, wherein the first diffusion region includes a plurality of diffusion regions of the first dopant type spaced apart from each other.

22. The device of claim 12 or 13, wherein the second diffusion region includes a plurality of diffusion regions of the first dopant type spaced apart from each other.

23. The device of claim 12 or 13, wherein the third diffusion region includes a plurality of diffusion regions of the second dopant type spaced apart from each other.

24. The device of claim 12 or 13, wherein the third diffusion region has a higher concentration of dopant than the first diffusion region or the second diffusion region.

25. An integrated circuit device for electrostatic discharge protection, comprising:
a resistive path formed in a semiconductor well of a first dopant type; and
a diffusion region of a second dopant type formed in the semiconductor well for keeping the resistive path at a low resistive state until a normal operation period occurs.

26. The device of claim 25, wherein the resistive path is defined by a first diffusion region of the first dopant type, a second diffusion region of the first dopant type, and the semiconductor well.

27. An electrostatic discharge protection circuit, comprising
a first terminal;
a second terminal;
an integrated circuit device including
a lightly doped region of a first dopant type;
a first diffusion region of the first dopant type formed at least partially in the lightly doped region and electrically coupled to the first terminal;
a second diffusion region of the first dopant type formed at least partially in the lightly doped region and spaced apart from the first diffusion region and electrically coupled to the second terminal; and
a third diffusion region of a second dopant type formed in the lightly doped region, and disposed between and spaced apart from the first and the second diffusion regions, the third diffusion region keeping a low resistive path between the first and second terminals until a normal operation period occurs, and
a control circuit for inducing a depletion region in the lightly doped region as the normal operation period occurs.

28. The circuit of claim 27, wherein the lightly doped region is formed in a semiconductor substrate.

29. The circuit of claim 27, wherein the lightly doped region is formed over an insulation layer.

30. The circuit of claim 27, wherein the first terminal is one of a contact pad or a voltage source.

31. The circuit of claim 27, wherein the second terminal is one of a contact pad or a voltage source.

32. The circuit of claim 27, wherein the depletion region is formed at a p-n junction disposed between the lightly doped region and the third diffusion region.

33. The circuit of claim 27, wherein the depletion region extends to a bottom surface of the lightly doped region.

34. The circuit of claim 27, wherein the lightly doped region, the first diffusion region, the second diffusion region, and third diffusion region are of a same depth.

35. A method of electrostatic discharge protection, comprising:
providing an integrated circuit device including
a lightly doped region of a first dopant type;
a first diffusion region of the first dopant type formed at least partially in the lightly doped region;
a second diffusion region of the first dopant type formed at least partially in the lightly doped region and spaced apart from the first diffusion region;
a resistive path defined by the lightly doped region, the first and the second diffusion regions; and
a third diffusion region of a second dopant type formed in the lightly doped region, and disposed between and spaced apart from the first and the second diffusion regions, the third diffusion region controlling the resistive state of the resistive path, and
keeping the resistive path at a low resistive state until a normal operation period occurs.

36. The method of claim 35, further comprising changing the resistive path to a high resistive state as the normal operation period occurs.

37. The method of claim 35, further comprising providing a control circuit coupled to the third diffusion region to induce a depletion region as the normal operation period occurs.

38. The method of claim 37, further comprising removing the depletion region as an electrostatic discharge event occurs.

39. A method of electrostatic discharge protection, comprising:
forming a resistive path in a semiconductor well of a first dopant type;
forming a diffusion region of a second dopant type in the semiconductor well to control a resistive state of the resistive path; and
keeping the resistive path at a low resistive state until a normal operation period occurs.

40. The method of claim 39, further comprising changing the resistive path to a high resistive state as the normal operation period occurs.
